(19) United States
(12) Patent Application Publication
(10) Pub. No.: US 2008/0259403 A1
(43) Pub. Date: Oct. 23, 2008

(54) IMAGE PROCESSING APPARATUS, VIEWER, IMAGE PROCESSING PROGRAM AND IMAGE PROCESSING SYSTEM

(76) Inventors: Minoru YAGUCHI, Tokyo (JP); Shunichi Kumakura, Tokyo (JP); Motoaki Aoyama, Tokyo (JP); Yukio Watanabe, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/032,363

(22) Filed: Feb. 15, 2008

(30) Foreign Application Priority Data
Apr. 19, 2007 (JP) JP2007-110319

(51) Int. Cl. H04N 1/405; G06K 9/00

(52) U.S. Cl. 358/3.28; 382/100

(57) ABSTRACT

An image processing apparatus including: an image reading section which reads an image containing a watermark having a hidden image and generates image data; and an image processing section which adds, onto the image data, information about image processing for preventing the watermark from being formed as a visible image when the image is reproduced based on the image data.

### CROSS REFERENCE TO RELATED APPLICATION

The present application is based on Japanese Patent Application No. 2007-110319 filed with Japanese Patent Office on Apr. 19, 2007, the entire content of which is hereby incorporated by reference.

### BACKGROUND OF THE INVENTION

1. Technical Field

This invention relates to the image processing technology, which processes and displays image information.

2. Prior Art

In order to prevent an illegal copy and illegal printing, when an image is reproduced with a copying machine or a printer, the technology about a watermarking processing, which processes a sheet of paper or writes a hidden image (an image, which is not able to be recognized by the naked eye, such as hidden label or texture) at the time when an original document is generated so that a copy guard image can be apparently formed with a reproduction image. The hidden image for the watermark comprises this technology as a pattern image of higher resolution (for example, 2400 dpi) than the image reading resolution (for example, 400-600 dpi) in usual copying machines. And when the original document, which has such watermark as a hidden image, is read with a copying machine or an image reading apparatus, a copy guard image is formed with a reproduction image by visualizing the watermark, without image reading resolution catching up with the resolution of a hidden image.

On the other hand, in order to read the watermark processed original document, without visualizing the watermark, it is necessary to read the original document in resolution higher than the resolution of the usual copying machines.

By the way, the electronic document law was enforced in Japan in 2005. This electronic document law is a general term for (1) the law about use of the art of the information and telecommunications in the storing of the document, which a civilian enterprise company performs (the general-rules law); and (2) the law about maintenance of the related law accompanying enforcement of the law about use of the art of the information and telecommunications in the preservation of a document, which a civilian enterprise company performs (the preparation law). According to these laws, in cases where not only a saved document (electronic document) created as an electronic document from the start, but also the image file (computerized document), into which the image reading apparatus reads the document created by a sheet of paper satisfies a certain level of technical requirement, the image file is accepted as the original document. According to this law, to be able to faithfully reproduce the original document by way of displaying or printing (visual readability) becomes the conditions, which are required for the electronic data as the original document.

For this reason, according to the electronic document law, image data of the watermark original document needs to be obtained by the high resolution reading process capable of precisely reading the watermark.

Although, a term called an electronic document is used in the following, as long as there is no notice in particular, the electronic document denotes both of an above-mentioned electronic document and a computerized document.

Although the electronic document based on the electronic document law is viewed by using a viewer in many cases, when viewing an electronic document including the information on the watermark, the watermark will be overlapped and formed in the image, which is the contents of the electronic document, as a visible image in the resolution (or resolution of a display) of a viewer, the image viewing becomes difficult or impossible.

Therefore, even if it is the electronic document, in which the watermark has been faithfully read as a hidden label, when the electronic document is viewed on the display, there is a problem of the watermark becoming visualized.

An object of this invention is to solve the aforementioned problem which arises in the case of the viewing of the electronic document obtained from the watermark original document.

### SUMMARY

To achieve at least one of the abovementioned objects, an image processing apparatus reflecting one aspect of the present invention includes:

an image reading section which reads an image containing a watermark having a hidden image and generates image data; and

an image processing section which adds, onto the image data, information about image processing for preventing the watermark from being formed as a visible image when the image is reproduced based on the image data.

The image processing apparatus reflecting another aspect of the present invention is characteristic in that the image processing section adds chroma information onto the image data as information about the image processing.

The image processing apparatus reflecting still another aspect of the present invention is characteristic in that the information about the image processing includes information, which specifies a viewer for reproducing an image.

### BRIEF DESCRIPTION OF THE DRAWINGS

These and other objects, advantages and features of the invention will become apparent from the following description thereof taken in conjunction with the accompanying drawings in which:

FIG. 1 illustrates a block diagram showing a configuration of an image forming apparatus pertaining to an embodiment of the present invention;

FIG. 2 illustrates an example of a TIFF file in which chroma information is written;

FIG. 3 illustrates a block diagram showing a configuration of a viewer pertaining to an embodiment of the present invention;

FIG. 4 illustrates a flowchart of a process of an image reading performed by the image processing apparatus shown in FIG. 1;

FIG. 5 illustrates a drawing showing a part of the flowchart of the process of the image reading performed by the image processing apparatus shown in FIG. 1;

FIG. 6 illustrates a flowchart of an image reproduction performed by the dedicated viewer shown in FIG. 3; and

FIG. 7 illustrates an image processing system pertaining to an embodiment of the present invention.

### DETAILED DESCRIPTION OF THE PREFERRED EMBODIMENT

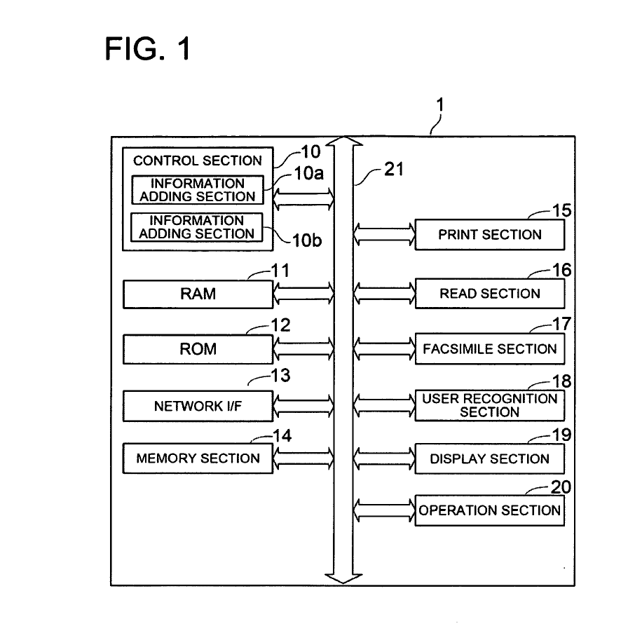

FIG. 1 illustrates a block diagram showing a configuration of an image processing apparatus pertaining to an embodiment of the present invention.

The image processing apparatus 1 is a multifunctional apparatus capable of reading an original document and printing an image. The image processing apparatus is configured by a control section 10, RAM 11, ROM 12, a network I/F section 13, a memory section 14, a print section 15, a read section 16, a facsimile section 17, an user recognition section 18, a display section 19 and an operation section 20, which are connected by a bus 21.

The control section 10 has CPU (Central Processing Unit), and performs a system control and an image processing of the entire apparatus. The control section 10 has an information adding section 10a for adding attribute information to image data read and obtained. As for added attribute information, there is attribute information specific to image information of the processing object such as chroma information, a resolution, and an ID for indicating a reading apparatus having read an original document or issuance of an original document. In addition, the control section 10 further includes an information adding section 10b.

The information adding section 10b gives additional information other than the above-mentioned attribute information to image data. As for the additional information, there are URL information and viewer adjustment information. The chroma information and the URL information are explained later.

RAM 11 is a memory for work utilized in information processing by CPU of the control section 10.

ROM 12 is a read-only memory for storing a control program and an image processing program.

Network I/F communicates with an external apparatus via a network to which the image processing apparatus is connected.

The memory section 14 is a memory section for storing user information, information of the image data, and processing history of the information. The memory section 14 is configured by a large capacity memory of HDD.

The print section 15 prints an image based on the image data onto a sheet of paper.

The reading section 16 as a reading section reads an original document, and generates the image data, namely, original document image information. In addition, the print section 15 has, for example, a resolving power of 2400 dpi, and is able to generate the image data including a watermark information of a watermark processed original document.

The facsimile section 17 is a communication section for performing a facsimile communication with outside. The facsimile section 17 transmits the image data generated by the read section 16. The information received by the facsimile section 17 is printed on a sheet of paper in the print section 15.

The user recognition section 18 recognizes a user with ID or a fingerprint.

The display section 19 is a user interface for receiving an operation of the image processing apparatus integrally formed with an operation section. The display section 19 displays the operation information along with an image based on the image data.

The operation section 20 includes a display integrated operation section integrally formed with the display section 19, a mouse, a keyboard, and other operation buttons.

First, the image data generated by the original document reading of the multifunctional apparatus, which being the image processing apparatus pertaining to an embodiment of the present invention in FIG. 1, is explained.

Although image data is included in the information read by the multifunctional apparatus shown in FIG. 1, when there is a watermark original document as this image data, the optical information of a watermark is included.

A watermark is embedded in the original document for the purpose of forbidding an illegal copying. The watermark is not conspicuous when viewing the original document with naked eyes. However, the watermark is visualized as a copy guard character (or a notation, or a drawing) when the original document is copied.

The watermark is usually formed of tiny dots, and when printed using a copying machine or a printer with the resolution (for example, 600 dpi) of a copying machine or a printer, a copy guard character emerges in a reproduction image. On the other hand, in case when a watermark processed original document image is read, for example, with a high resolution of 2400 dpi, an image data including information for being capable of precisely reproducing the watermark is generated.

In case when the read information generated by reading with such high resolution is copied in the higher resolution than the time of the reading, the visible image of a watermark will not be reproduced as a visual image, but in case when it is copied in lower resolution than the time of the reading, the visible image (visual image) by a watermark will be formed.

Since the resolution of the usual copying machine, a printer, or a viewer is not more than 400-600 dpi, the watermark forms a visible image. This enables it to forbid an illegal copying.

In this embodiment of the present invention, in order to have the watermark not formed as the visible image even in case when a copy guard character formed as a visible image is displayed in the resolution, such as 400-600 dpi, chroma information is added as information for performing the image processing. In addition, as information related to this image processing, it is not limited to the chroma information, and it may be the information of a density, a contrast, and sharpness.

In an embodiment of the present invention, image information is created by the existing file format, for example, TIFF (Tagged Image File Format).

In many cases, an area in which information distinctive to each image information is provided in the file format.

In this embodiment of the present invention, chroma information is written in this area.

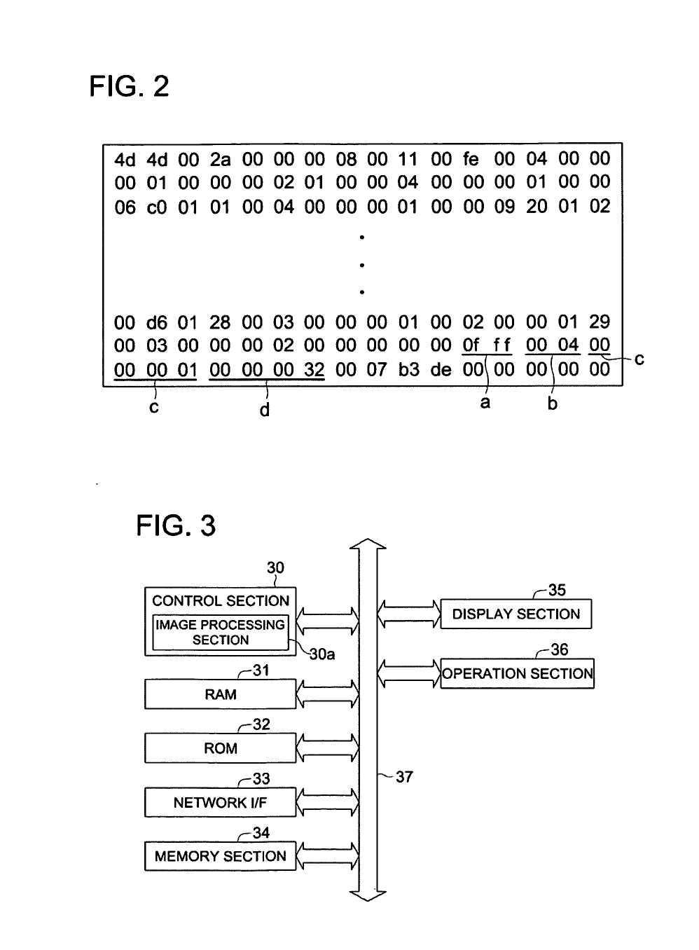

FIG. 2 shows an example of the TIFF file in which the chroma information is written, and specifically shows the binary data of a tag section of the first page of TIFF. In the drawing, a-d are parts showing the above mentioned chroma information.

“a” shows a tag number of 2 bytes and is set as not to overlap with other existing tag numbers. As for the chroma information, a value of either “0ffff” or “0eee” is utilized. “0fff” shows that the chroma information for making a watermark not conspicuous at the time of image reproduction is uncalculated. “0eee” shows that the chroma information for making a watermark not conspicuous at the time of reproduction is calculated.

“b” is a part that shows data types and the example shown in the drawing implies that it is a LONG type.

“c” shows a length of data and the example shown in the drawing (“00000001”) implies that 1, namely, denotes 4 bytes. “d” is the chroma information and in example shown in the drawing “0×32”, namely, 50 shows the chroma information.

The dedicated viewer for displaying an image is related to the chroma information, for example, the dedicated viewer “A” corresponds to a chroma “A”, and the dedicated viewer “B” corresponds to a chroma “B”. Thus, by corresponding a chroma and a dedicated viewer, the viewer being capable of displaying an electronic document forbidding an illegal copying without displaying a watermark (without visualization) is limited to a specific viewer.

Furthermore, as for the chroma information, there are the calculated chroma information having been calculated to the value specifying the viewer as mentioned above, and the uncalculated chroma information. In case when the chroma information is uncalculated, the dedicated viewer calculates the optimal chroma and with this optimal chroma, the image processing is performed to the image data.

When displaying an image from the image information on a viewer or printing an image from the image information, image processing for displaying an image without visualizing the watermark is performed using the added chroma information.

FIG. 3 illustrates a block diagram showing the configuration of the viewer pertaining to an embodiment of the present invention.

The dedicated viewer 3 is a common personal computer capable of displaying the image. The dedicated viewer 3 has a configuration of control section 30, RAM 31, ROM 32, a network I/F section 33, a memory section 34, a display section 35, and an operation section 36 where all are connected with bus 37.

The control section 30 is configured by CPU. The control section 30 performs image processing to prevent visualization of the watermark information based on the chroma information by executing the program stored in ROM32.

When the luminance of the watermark is uncalculated, as for this image processing, there is a process for keeping the watermark image from being conspicuous by calculating this luminance. For this image processing, for example, the method indicated in Unexamined Japanese Patent Application Publication No. 2005-301713 (JPA2005-301713) could be used. Namely, the luminance value of the pixel of coordinates (m, n) is assumed to be K(m, n) based on the image information, gradation difference E(m, n) shown by a lower formula (1) will be obtained. This gradation difference serves as an indicator for showing the degree of change of the luminance value between the adjoining pixels in each pixel.

E(m, n)=|K(m−1, n)−K(m+1, n)|+|K(m, n−1)−K(m, n+1)| (1)

Then, the edge area pixel for satisfying the below formula (2) is extracted from the each pixel having the gradation difference obtained.

E(m, n)>β (2)

Here, β shows arbitrary values.

Then, a histogram is created for the luminance value of the extracted edge area pixel, and the luminance values in the 1st and the 2nd peaks from the high luminance side in this histogram are detected respectively as a peak luminance value of a ground color and the peak luminance values of the watermark. Here, by detecting only the peak exceeding a predetermined luminance value, the error detection of the peak value of a ground color and the peak value of a watermark can be avoidable.

Next, the trough luminance value of two troughs in the left and right of the crest being the peak value of the watermark in this histogram is detected. All the luminance values, which are in the range of both of these trough luminance values among the data of each pixel, are changed into the luminance value of a ground color. Thus, the luminance of the watermark is calculated, and the processing to keep the watermark image from being conspicuous can be attained.

Namely, the method of detecting the watermark from the histogram can be performed after the edge area pixel is extracted and the histogram of the edge area pixel is created.

By this method, the peaks of the histogram corresponding to the background, the watermark and the image of the original document are obtained.

A watermark is removed by making the luminance value of the pixel in the range of the peak corresponding to the watermark of these peaks into a steady value.

The addition of the watermark information at the time of image reading and the display process of the watermark at the time of image restoration are explained hereinafter.

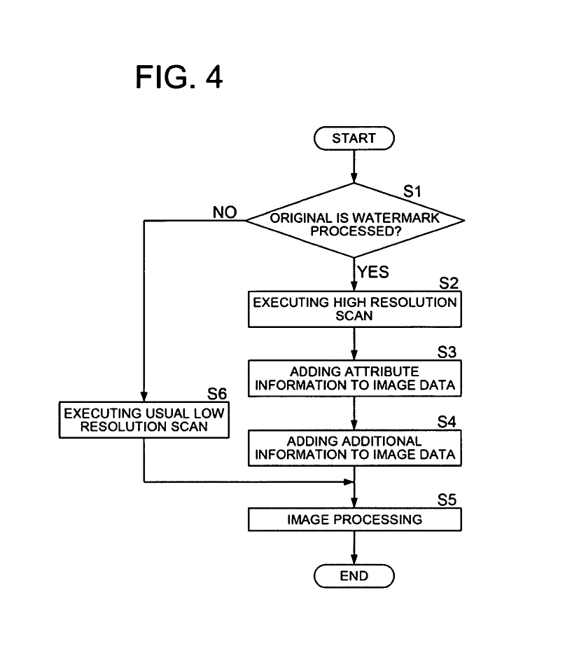

FIG. 4 is a flowchart of the process of image reading performed by the image processing apparatus shown in FIG. 1. This process is performed by CPU of the control section 10 executing the program stored in ROM 12.

In STEP S1, it is determined whether an original document is a watermark processed original document or not.

This determination is made based on a setting in the operation section 20 that an original document is a watermark original document.

In case when the original document is determined to have the watermark by the determination of STEP S1 (STEP S1: YES), it proceeds to STEP S2. Then, the image reading is performed, for example, in a high resolution of 2400 dpi, namely, the resolution capable of precisely reading all the information on the original document including the watermark information.

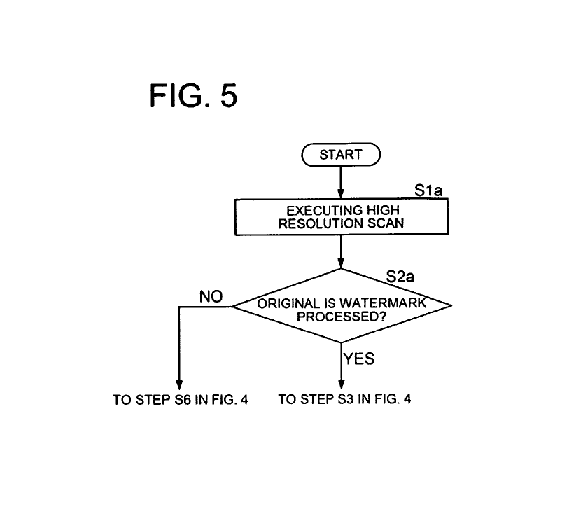

In addition, as for STEPs S1a and S2a in FIG. 5, in replacement of STEPs S1 and S2, the process of image reading may be performed by analyzing the image data obtained by reading the original document image by high resolution. As for the determination shown in FIG. 5, for example, the method of detecting an existence of the watermark from a histogram can be taken after extracting the edge area pixel and creating a histogram related to the luminance of the edge area pixel, namely, the method indicated in the above-mentioned JPA2005-301713.

Then, the attribute information is added to the image data obtained by the reading (STEP S3). The added information will be the attribution of the read original document image and image data. The added information is such as the resolution at the time of reading, ID showing the reading apparatus having read the original document, or issuance of the original document, and the chroma information.

The chroma information indicates that an original document image is a watermark original document, and is added to every page of the original document or every reading job of original document. In addition, the added chroma information may be calculated to the optimal value or may be uncalculated.

Additional information is added in the next STEP S4. As for the additional information, there are information specifying the dedicated viewer, and URL being a place to obtain the program for the viewer and monitor adjustment information.

In STEP S5, the usual image processing, namely, image processing such as the process of changing into density from luminance is performed.

Thus, the chroma information for a watermark process and the information relating to the process of the watermark at the time of image restoration are added to the image information generated by reading the original document.

Further, when determined that it is not an original document of watermark in STEP S1, reading is performed with the usual low resolution (step S6).

In the determination of STEP S1 of FIG. 4, or in the determination of STEP S2a of FIG. 5, in case when it is determined that it is not a watermark original document, the usual image processing is performed in STEP S5.

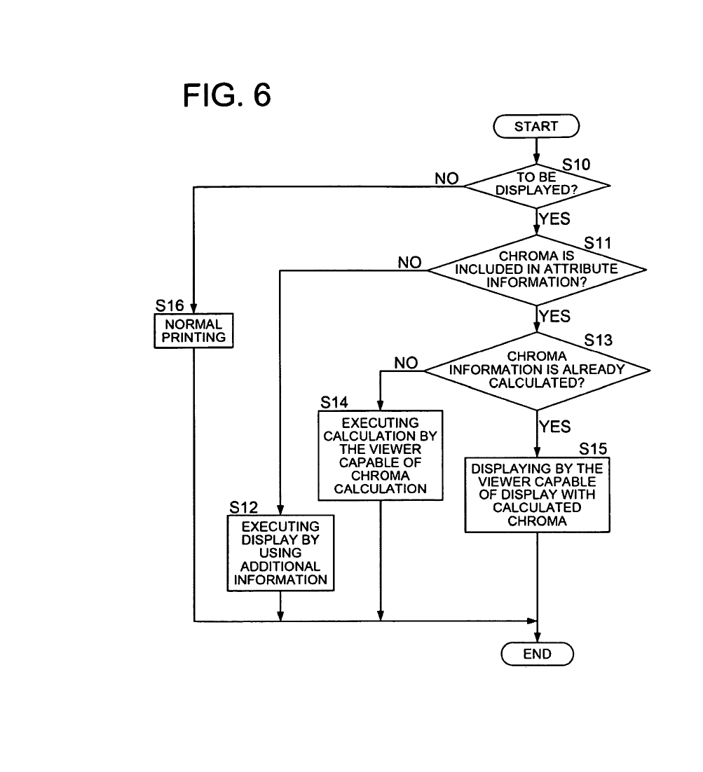

FIG. 6 illustrates a flowchart of the image restoration performed by the dedicated viewer shown in FIG. 3. This process is realized by CPU of the control section 30 executing the program stored in ROM 32.

First, it is determined to be displayed or to be printed in STEP S10. This determination is made based on an operation of an operator.

In the case when it is determined to be displayed in STEP 10 (STEP S10: Yes), it is determined whether the chroma information is given to the image information in STEP S11.

When the chroma information is not given (STEP S11: No), image information is displayed using the additional information, namely, the information directing the dedicated viewer (STEP S12). Here, the image data shown on the display in STEP S12 does not have chroma information, namely, image data of the image not containing the watermark. Therefore, even if particular image process was not performed to the image displayed in STEP S12, the visible image by a watermark does not appear.

When it is determined that chroma information was given at STEP S11 (STEP S11: Yes), it is determined whether the chroma is calculated or not in STEP S13.

When the chroma information has been calculated (STEP S13: Yes), the dedicated viewer capable of displaying an image with the calculated chroma is selected. Then the dedicated viewer displays the image (STEP S15).

In the display in STEP S15, since the process for not visualizing a watermark is performed by conducting image processing to the image data by utilizing the chroma information, a watermark does not appear in the image displayed (or it is not conspicuous).

When the chroma has not been calculated in STEP S13 (STEP S13: No), the dedicated viewer calculates the chroma, and an image display is performed after performing the image processing using the calculated chroma information in STEPs S14.

As a result, an image without the visible image of the watermark is displayed in the display of STEP S14.

Meanwhile, in case when it is determined to be printed in STEP S10 (STEP S10: No), printing is performed in STEP S16. In this printing, when watermark information is included, a copy guard character is formed as a visible image.

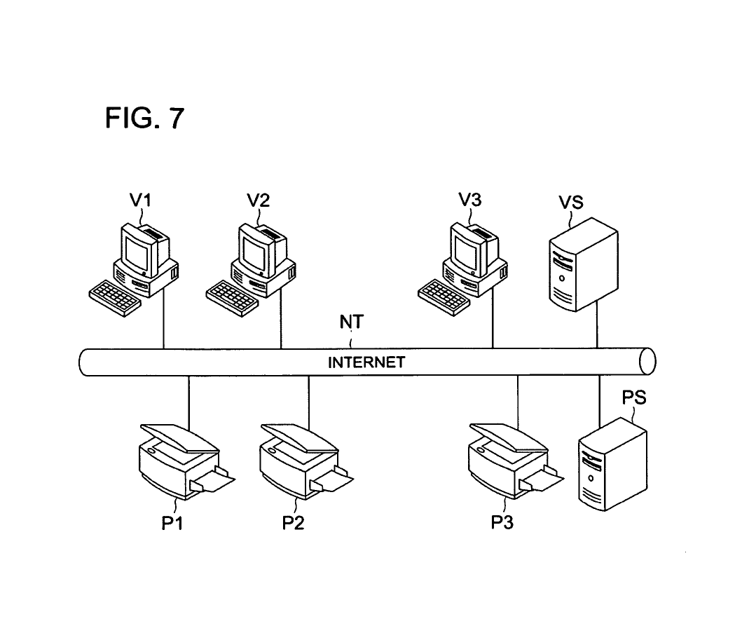

FIG. 7 shows the image processing system pertaining to an embodiment of the present invention.

Viewers V1-V3, the image processing apparatus P1-P3, server VS for the viewer, and image processing server PS are connected via the Internet or the network NT of such as the LAN.

The image processing apparatus P1-P2 are the multifunctional apparatus shown in FIG. 1. The image processing apparatus P1-P2 perform image reading and printing based on image data, and add the chroma information explained above to the image information.

In the system shown in FIG. 7, as for the dedicated viewers V1-V3, the dedicated viewers having the following functions can be used. (a) The dedicated viewer having an image processing program for the watermark mentioned above. (b) The dedicated viewer having URL (Uniform Resource Locator) for accessing the server having an image processing program for the above mentioned watermark and having a program that downloads the above-mentioned image processing program from the above-mentioned server. (C) The dedicated viewer having URL for accessing the server having an image processing section to process by the image processing program for the above mentioned watermark and having a program that downloads the image information to which image processing to a watermark from the above mentioned server was performed.

Server VS is equipped with a memory section to store the program for image information and a watermark process in correspondence to such dedicated viewer. The server VS provides (a) image information; or (b) program for image information and the watermark process corresponding to the request of the dedicated viewers V1-V3.

In addition, the server VS includes an image processing section to perform image processing, which prevents the formation of the visual image of a watermark based on chroma information. The server VS may be configured such that the server performs the above-mentioned image processing corresponding to the request of the dedicated viewers V1-V3, and transmits the processed image information to a dedicated viewer.

According to the present invention, it becomes possible to display an image without forming a watermark as a visible image when viewing the electronic document containing watermark information. Even if it is an electronic document obtained by reading of a original document or it is an electronic document created based on e-document law, it becomes possible to display an image in a state of not forming a watermark as a visible image.

In addition, the electronic document created by the present invention includes watermark information in case when the original document is the watermark original document. Since a watermark, namely, a copy guard character is formed as a visible image in a usual copying, printing, or displaying, the function to forbid an illegal copying is not detracted.

What is claimed is:

1. An image processing apparatus comprising:
an image reading section which reads an image containing a watermark having a hidden image and generates image data; and
an image processing section which adds, onto the image data, information about image processing for preventing the watermark from being formed as a visible image when the image is reproduced based on the image data.

2. The image processing apparatus of claim 1, wherein the image processing section adds chroma information onto the image data as the information about image processing.

3. The image processing apparatus of claim 2, wherein the image processing section adds additional information other than the chroma information in addition to the chroma information onto the image data.

4. The image processing apparatus of claim 1, wherein the information about the image processing comprises information for specifying a viewer which reproduces the image.

5. The image processing apparatus of claim 3, wherein the additional information comprises attribute information of the image.

6. The image processing apparatus of claim 3, wherein the additional information comprises a URL information of a site from which obtained is a program for image processing to prevent the watermark from being formed as a visible image when the image is reproduced, or a URL information of a server which performs the image processing to prevent the watermark from being formed as a visible image when the image is reproduced.

7. A viewer comprising an image processing section, wherein the image processing section, based on image processing information added onto image data of an image including a watermark, (1) executes an image processing on the image data, or (2) allows an external apparatus to execute the image processing on the image data and obtains the image processed image data to prevent the watermark from being formed as a visible image when the image is reproduced.

8. A computer readable medium stored therein a program for allowing a computer to detect image processing information added onto image data of an image including a watermark having a hidden image, and to execute, based on the detected image processing information, a process of reproducing the image with preventing the watermark from being formed as a visual image by (1) executing an image processing on the image data, or by (2) allowing an external apparatus to execute the image processing on the image data, and obtaining the processed image data.

9. An image processing system comprising:
an image processing apparatus which comprises; an image reading section which reads an image containing a watermark having a hidden image and generates image data, and a first image processing section which adds, onto the image data, information about image processing for preventing the watermark from being formed as a visible image when the image is reproduced based on the image data;
a viewer which, based on the information about image processing added onto the image data, (1) executes an image processing on the image data, or (2) allows an external apparatus to execute the image processing and obtains the processed image data to display the image based on the processed image data; and
a server which stores the image data generated by the image processing apparatus.

10. The image processing system of claim 9, wherein the server comprises a memory section which stores a program to prevent, based on the information about image processing added onto the image information, the watermark from being formed as a visible image in the displayed image.

11. The image processing system of claim 9, wherein the server comprises image processing section which, based on the information about image processing added onto the image information executes the image processing to prevent the watermark from being formed as a visible image in the displayed image.
